(19) United States
(12) Patent Application Publication
(10) Pub. No.: US 2020/0248485 A1
(43) Pub. Date: Aug. 6, 2020

(54) Cargo Door Protective Handle and Hasp Cover

(71) Applicant: Lyle T Clark, New Braunfels, TX (US)

(72) Inventor: Lyle T Clark, New Braunfels, TX (US)

(21) Appl. No.: 16/269,486

(22) Filed: Feb. 6, 2019

(51) Int. Cl. E05B 67/38; E05B 13/00; E05C 19/08

(52) U.S. Cl. CPC E05B 67/38; E05C 19/08; E05B 13/002

(57) ABSTRACT

A protective cover that deters theft and destruction of property through prevention of unsanctioned opening of a camming door handle. The device utilizes a cross-shaped design to partially cover a cam bar up to its pin hinge and the hasp to which it is attached. Lateral walls perpendicular to and at the intersection of the cross-shaped front wall enclose the hasp from the sides, and a perpendicular wall with aperture axially aligned with those of the hasp serves to connect the device to the hasp. A rounded bracket on the backside of the cover prevents the use of the cover as a lever to pry at or twist the hasp. The cover is installed by means of sliding the apparatus over the cam bar and through the bracket until centered upon the door hasp, at which time it may be held in place through use of an adequate locking mechanism.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

Many cargo trucks, trailers, and containers contain swing-out or ramp doors. These doors often rely upon a camming handle arm to open. A hasp holds said handle into place, and may be secured with a padlock or similar mechanical locking device. However, hasps and simple padlocks are particularly vulnerable to damage imposed by tools such as bolt cutters and chisels. Additionally, cargo door handles and external hinges to which they are connected are susceptible to destruction by portable saws and files.

It is therefore desirable to produce a device capable of protecting a hasp-sealed cargo door from breakage with the purpose of gaining unlawful entry to the cargo container within. To accomplish this, the device should be capable of resisting physical attacks from the front, top, sides, and bottom. Additionally, it should be capable of fully enclosing the hasp which it protects in order to prevent damage to existing hasp elements. Lastly, the device should partially or completely cover and protect the cargo door handle which it is installed upon.

U.S. Pat. No. 5,118,149, issued to Emmons, describes a hasp protector for use on hasp-sealed container doors. A protective plate on the front of the device protects the hasp from intentional frontal breakage by tools. The box-like, or alternatively, hemispherical shape of the device conceals and protects the hasp from all visible sides.

U.S. Pat. No. 6,581,419 B1, issued to Strodtman, describes a box-like hasp and lock cover with an open backside and bottom end, allowing the user to insert and remove a lock while allowing the device to remain attached to the cargo door. Apertures on the lateral sides of the device allow for the slidable receiving of the cargo door handle. An opening on the top in the general form of a hasp allows for the release of the cargo door handle from the hasp, resulting in the ability of the cargo door to open with the hasp and lock cover remaining on the the camming door handle.

Patent Application Publication U.S. 20120103032 A1, published to Thomsen, describes a one-piece security cover for shipping containers that fully encloses the hasp and handle of the the cargo door to the hinge. The device is installed upon the existing hasp element by fitting the cover directly over the hasp and securing the device in place with a locking pin which is extended through the holes in the top and bottom of the cover aligned with those of the hasp.

### BRIEF SUMMARY OF THE INVENTION

A protective cover that deters theft and destruction of property through prevention of unsanctioned opening of a camming door handle. The hasp and handle cover utilizes a cross-shaped design to fully or partially cover a cam bar up to its pin hinge and the door hasp to which it is attached. Lateral walls perpendicular to and at the intersection of the cross-shaped front wall enclose the hasp from the sides, and a perpendicular wall with aperture axially aligned with those of the hasp serves to connect the device to the hasp. A rounded bracket on the backside of the cover prevents the use of the cover as a lever to pry or twist open the hasp. The cover is installed by means of sliding the apparatus over the cam bar and through the bracket until centered upon the door hasp, at which time it may be held in place through use of an adequate locking mechanism.

### BRIEF DESCRIPTION OF THE SEVERAL VIEWS OF THE DRAWING

FIG. 1 shows a front elevation of the handle and hasp cover according to the present invention.

FIG. 2 shows a rear elevation of the handle and hasp cover according to the present invention.

FIG. 3 shows a side-view of the handle and hasp cover according to the present invention.

FIG. 4 shows a plan view of the handle and hasp cover from above.

FIG. 5 shows a perspective view of the handle and hasp cover from the top and back side.

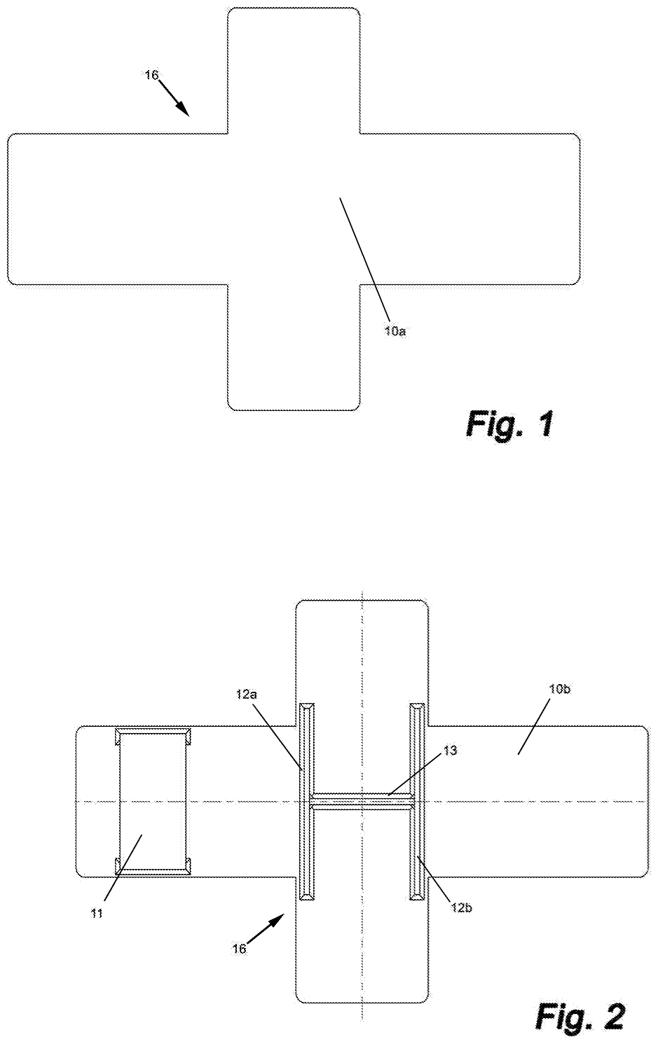

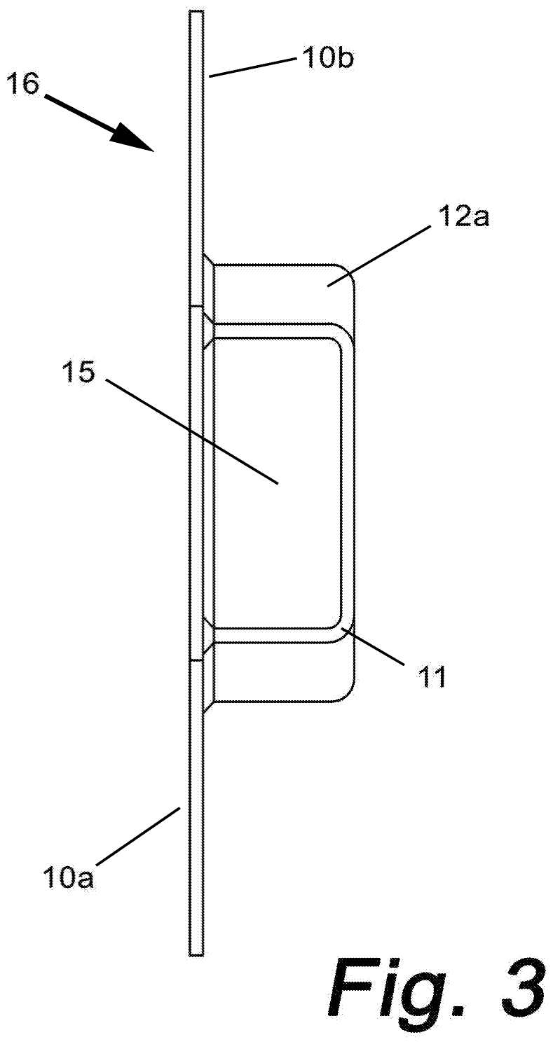

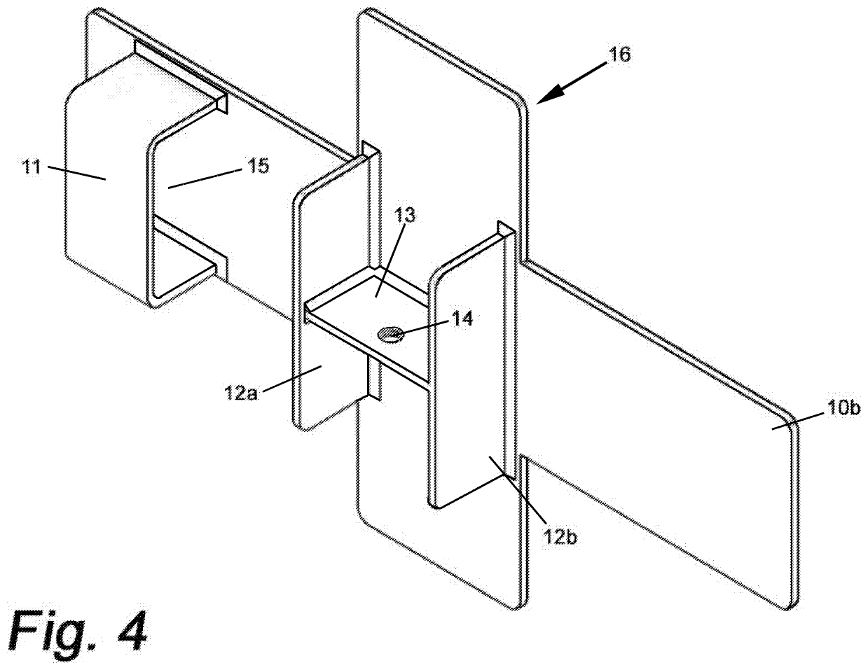

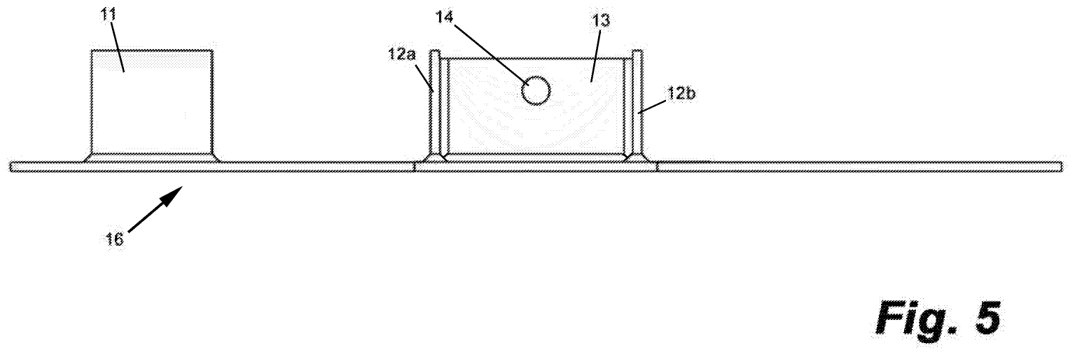

### DETAILED DESCRIPTION OF THE INVENTION

The preferred embodiment of the protective cover in accordance to the present invention is denoted by the numeric label 16. The cover 16 comprises of a cross-shaped front plate 10a with dimensions sufficient enough to fully cover existing hasp elements and part or all existing cargo door handle element. Attached (e.g. by welding) to the back of said plate 10b are two laterally opposed walls 12a and 12b, a perpendicular wall 13 orthogonal to and bisecting said lateral walls 12a and 12b with aperture 14 axially aligned with those of existing hasp elements, and a bracket 11 with aperture 15 composed of the space between said bracket 11 and said plate 10b.

The aperture 15 formed from the space between the back of the frontal plate 10b and said bracket 11 is of the general form of a cargo door handle, and is of sufficient dimensions for the slidable receiving of a cargo door handle. The aperture 14 within the wall 13 is of dimensions similar to those of the hasp to which it is aligned, and dimensions sufficient for the slidable receiving of the shaft of a coupler lock or other adequate locking mechanism.

With the handle of the cargo door already in the closed position, the user may install the cover 16 upon a cargo door by first inserting the door handle through the bracket aperture 11, with the cover 16 oriented so that the arm to which the bracket 11 is attached is farthest away from the hinge of the handle. The user may then slide the cover 16 over the door handle until the aperture 14 is aligned with those of the door hasp. Lastly, the cover 16 may be secured to the hasp by insertion of a locking device through the aligned apertures of the hasp and horizontal wall 15.

The preferred embodiment of the cover 16 is made of hardened steel, but may be made from any material capable of resisting damage from physical attacks caused by tools such as bolt cutters and pliers. Additionally, a spray-on coating of polyurethane or other protective material may be applied to the cover for added durability and to prevent oxidation.

It is to be understood that the present invention is not limited to the embodiments described above, but encompasses any and all embodiments within the scope of the following claims.

What is claimed is:

1. A protective cover comprising:
a cross-shaped contiguous front wall of dimensions sufficient to cover existing door hasp and part or all of existing camming door handle;
two laterally opposed walls connected to the back of said front wall with dimensions sufficient to cover sides of existing door hasp elements;
a perpendicular wall orthogonal to and bisecting said laterally opposed walls with aperture axially aligned with those of existing door hasp to join with said hasp through use of an adequate locking mechanism; and
a bracket attached to the back of said front wall whose aperture allows for the receiving of existing camming door handle and prevention of use of the apparatus as a lever for prying or twisting of existing hasp elements.

2. The protective cover according to claim 1, wherein said bracket when attached to the back of said front wall forms an aperture in the shape of the general form of existing camming door handle to allow said handle to be slidably received.

3. The protective cover according to claim 1, further comprising the application of a protective coating to allow increased durability of said cover from physical wear and prolonged protection of said cover from oxidation.
